(19) United States
(12) Patent Application Publication
(10) Pub. No.: US 2010/0223345 A1
(43) Pub. Date: Sep. 2, 2010

(54) COMMUNICATIONS APPLICATION HAVING CONVERSATION AND MEETING ENVIRONMENTS

(75) Inventors: Amit Gupta, Redmond, WA (US); Bob Serr, Kirkland, WA (US); Avronil Bhattacharjee, Redmond, WA (US); Marcelo D. Truffat, Woodinville, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/395,729

(22) Filed: Mar. 2, 2009

(51) Int. Cl. G06F 15/82

(52) U.S. Cl. 709/206

(57) ABSTRACT

Architecture for a communication system providing a user experience that includes a conversation environment and a meeting embodiment in a single application. A navigation menu enables the user to select between multiple communications environments, including a conversations environment. Multiple conversation threads can be accessed in various conversation formats, including formats associated with instant messaging, group chat, a telephone call, voice, video, email, application sharing, or an online meeting. A meeting environment can be navigated for accessing one or more meetings. Other suitable communications environments can be also be navigated from the same navigation menu, besides the conversation environment and meeting environment. The communications system and application also includes a selection pane for displaying a list of the conversation threads or meetings, depending on the environment selected by the user. A preview pane can also be included in the communications system.

### BACKGROUND

Communications applications are available for enabling users to have conversations in which synchronous, real-time communication is occurring between parties. For example, conversations have traditionally been held over telephones, though telephone conversation capability has been extended through conference calling, video conferencing, and multiple party conversations via voice over IP (VoIP).

In addition to telephone, conversations have come to include text-based forms of real-time communication such as instant messaging and group chat. In these approaches, two or more users exchange text messages that are transmitted and read by all users. The users participate in an exchange of messages that occurs synchronously for all users. In this way, synchronous text-based conversations can differ from communications such as email in which the parties are not in synchronous, real-time communication, but exchange messages over extended periods of time.

Network-based meetings are also performed online in which one party shares a computer desktop or application with one or more other parties over a network connection. In this way, all meeting participants are able to view a common presentation and interact to exchange ideas. A meeting can be any type of collaboration session, including those in which each participant can speak to the other participants or exchange text messages, for example.

Typically, different applications can be used for conversations and meetings. Oftentimes, a different application is used for each different type of conversation, for example, an instant messaging application for texting and a separate VoIP application for voice conversations over IP networks. Additionally, instant messaging, chat threads, and recorded VoIP conversations can be saved for future reference. However, it can be difficult, for example, for a user to organize the various conversation applications and locate saved conversations in addition to managing a separate meeting application.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

To that end, architecture is disclosed for bringing a conversation environment and a meeting environment into a single communications application. In this way, a user experience is provided that enables communication and collaboration around applications and related topics, projects and documents rather than verbal or text-based communication.

The communications application includes a meeting component for providing a meeting environment to the user. The meeting component enables the user to select a particular meeting from multiple meetings. A meeting schedule component tracks scheduled online meetings defined according to a list. An ad hoc collaboration component enables the user to create an ad hoc meeting. In this way, users can initiate, interact and manage meetings seamlessly inside a single communications application. The meetings environment also enables the user to manage content related to one or more of the meetings, such as applications, documents and other pre-meeting or post-meeting content.

The communications application also includes a conversation component for providing a conversation environment to the user. The conversation component enables the user to manage multiple conversation threads. The multiple conversation threads can be in any suitable format, such as instant messaging, group chat, telephone calls, or an online meeting. The conversation threads can include active conversation threads, past conversation threads, and persistent conversation threads, for example. The communications application also enables the user to perform searches of the meetings and conversations.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented system for performing communications.

FIG. 2 illustrates aspects of the meeting component as used with the computer-implemented system for performing communications.

FIG. 3 illustrates a content management component for managing content related to meetings.

FIG. 4 illustrates additional aspects of conversation threads managed by a conversation component.

FIG. 5 illustrates an alternative embodiment of the computer-implemented system for performing communications.

FIG. 6 illustrates additional aspects of types of conversations items displayed in a selection pane.

FIG. 7 illustrates a method of communications.

FIG. 8 illustrates further aspects in the method of communications.

FIG. 9 illustrates additional aspects in the method of communications.

FIG. 10 illustrates still further aspects in the method of communications.

FIG. 11 illustrates a user interface for accessing a meeting environment.

FIG. 12 illustrates a user interface for accessing a conversations environment and a meeting environment.

FIG. 13 illustrates a block diagram of a computing system operable to execute the communications in accordance with the disclosed architecture.

FIG. 14 illustrates an exemplary computing environment operable to provide communications.

### DETAILED DESCRIPTION

The disclosed communications architecture provides a user experience that includes a conversation environment and a meeting embodiment in a single real-time communications application. Real-time communications applications are people-centric, and all communications are only centered on people. As VoIP solutions evolved, a phone environment has been added; however, the introduction of conversations and meeting into the real-time application provides a rich user experience for addressing modalities heretofore not available in a single real-time communications application.

A navigation menu enables the user to select between multiple communications environments, including a conversations environment and a meeting environment, among other selections. Multiple conversation threads can be accessed in various conversation formats, including formats associated with instant messaging, group chat, a telephone call, voice, video, email, application sharing, and an online meeting, for example. A meeting environment can be navigated for accessing one or more meetings. Other suitable communications environments can be also be navigated from the same navigation menu, besides the conversation environment and meeting environment.

The disclosed architecture brings the management of different types of conversations (e.g., text-based, audio-based, etc.) into a single communications application, thus allowing a user to navigate and move seamlessly between conversations. Real-time messaging applications are “people-centric” since the various modalities of communication are centered on people and associated human interactions. A “meeting” is a specialized type of interaction where users are collaborating with multiple modalities (e.g., voice, text, video, documents, desktop sharing, etc.). A conversation on the telephone or with text can be escalated to a meeting experience. Conversely, a meeting can lead to a follow-up conversation on a phone or conference call. Rather than using multiple separate applications for these interactions, incorporating both a conversation environment and a meeting environment into a single communication application allows the user to navigate through ad hoc and scheduled communications, follow-up on past and missed conversations and escalate these communications into an immersive real-time meeting experience.

The communications system and application also includes a selection pane for displaying a list of the conversation threads or meetings, depending on the environment selected by the user. The selection pane can include a list of active conversation threads or meetings, as well as lists of history conversation threads or meetings and persistent conversation threads or meetings. A preview pane can also be included in the communications system. The preview pane displays a preview of a specific item from the list shown in the selection pane.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

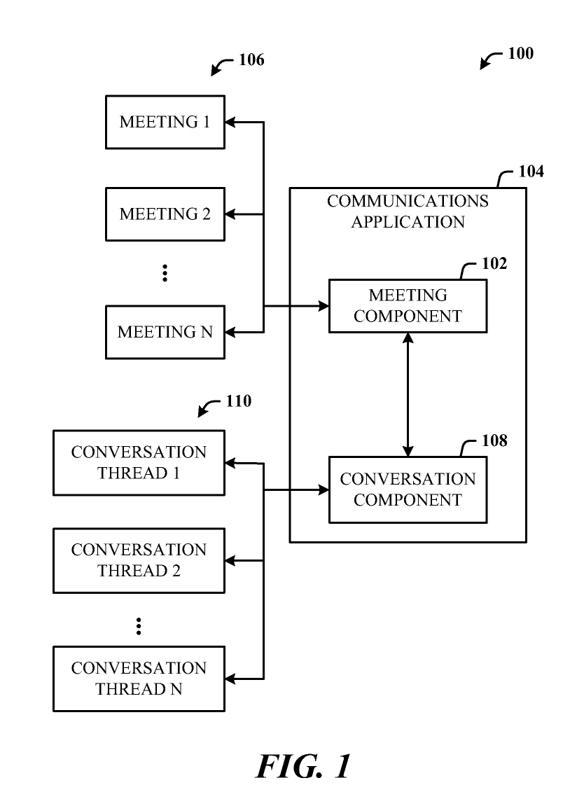

FIG. 1 illustrates a computer-implemented system 100 for performing communications. The system 100 provides a single user experience for accessing multiple communications environments to facilitate communications and collaboration between users (e.g., groups). The communications environments can include a meeting environment and a conversation environment. The meeting environment is established through a meeting component 102, which is part of a communications application 104. The meeting component 102 enables the user to select a meeting from multiple meetings 106. The conversation environment is established through a conversation component 108, which is also part of the communications application 104. The conversation component enables the user to manage multiple conversation threads 110.

Through the meeting component 102, the meeting environment provides easy access to online meetings and related content. The meeting component 102 enables online meetings to be created in the communications application 104 that are available in the meeting environment. The meeting component 102 provides access to meeting-related content stored on external applications, such as a remote server. The meeting component 102 also provides one-click access to join available meetings displayed within the communications application 104, as discussed in detail hereinbelow. Additionally, a user can search all meetings to which access is available. In these ways, the meeting component 102 enables a range of online conferencing capabilities to become integral parts of meetings and provides users with a single application to join and participate in meetings.

The conversation component 108 provides conversation management for users participating in multiple online conversations. This helps users organize conversation threads 110 according to individual users or topics. A user can also browse or search other ongoing conversation threads 110 related to a given topic or project, as will be set forth in greater detail hereinbelow. It is to be appreciated that conversation threads 110 can be associated with different conversation types, including but not limited to, instant messaging, group chat, telephone calls, video, and/or an online meeting.

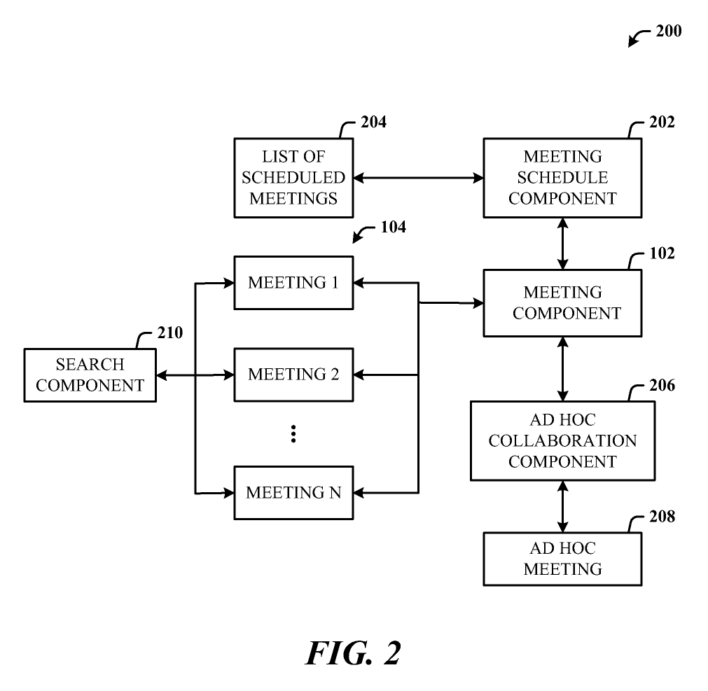

FIG. 2 illustrates aspects of the meeting component 102 as used with the computer-implemented system 100 for performing communications. A meeting schedule component 202 enables the tracking of scheduled online meetings defined according to a list 204 of scheduled meetings. The meetings shown on the list 204 can include active and/or tagged meetings. The meeting schedule component 202 allows the user to obtain quick access to online meetings that are currently active or tagged by the user. The list 204 can also include scheduled upcoming meetings. The list 204 can be saved on a user's local application or accessed from a remote network server.

FIG. 2 also illustrates an ad hoc collaboration component 206 that can be used for creating an ad hoc meeting 208. This allows a selected group of users to create meetings “on the spot” with a single click in the user interface of the communication application 104 (of FIG. 1), rather than creating a scheduled meeting in advance. In this way, the user can open and access a virtual meeting conference room to start an ad hoc collaboration at any time.

As also illustrated in FIG. 2, a search component 210 can be used for performing searches of the multiple meetings. This enables the user to locate meetings or content that can be related to a specific, project, or site, located on a network server or other remote storage location. In one aspect, metadata can be incorporated into meetings as part of an existing meeting file or as a separate, associated index file. Thus, the search component 210 enables a search of meetings to be performed.

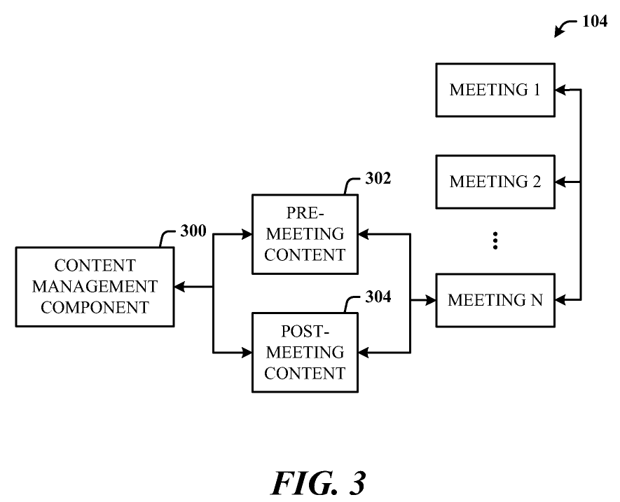

FIG. 3 illustrates a content management component 300 for managing content related to meetings. The content management component 300 can manage pre-meeting content 302 and post-meeting content 304 related to at least one of the multiple meetings 106. This pre-meeting content 302 and post-meeting content 304 can be shared with other users participating in a particular meeting. The pre-meeting content 302 can include background information related to the meeting, so that the users can review content files prior to the meeting as part of meeting preparation. The post-meeting content 304 can be reviewed after the meeting so that the users can implement or take action on subjects discussed in the meeting. In this way, quick sharing of meeting content with all participants can be facilitated, providing a useful meeting environment through the communication application 104.

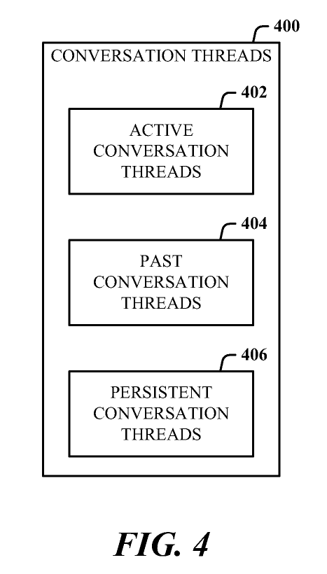

FIG. 4 illustrates additional aspects of conversation threads 400 managed by the conversation component 108. The conversation threads 400 include active conversation threads 402. The conversation component 108 can manage active conversations by enabling the user to quickly shift between active conversations with one or more persons in multiple different modalities. For example, the user can access an active instant messaging thread, while concurrently engaged with a phone conversation, a video conference, and/or an application sharing session.

The conversation threads 400 can also include past conversation threads 404. The conversation component 108 enables the user to view a conversation history of recent or old conversation threads 404 and quickly restart a conversation.

The conversation threads 400 can also include persistent conversation threads 406. The conversation component 108 enables the user to view, create, and manage topic or group-centric conversations that persist over a period of time between multiple users. It is to be appreciated that the conversation threads 400 can include other types of conversations in addition to those indicated hereinabove, and that the conversation threads 400 depicted are not to be construed as limiting in any way.

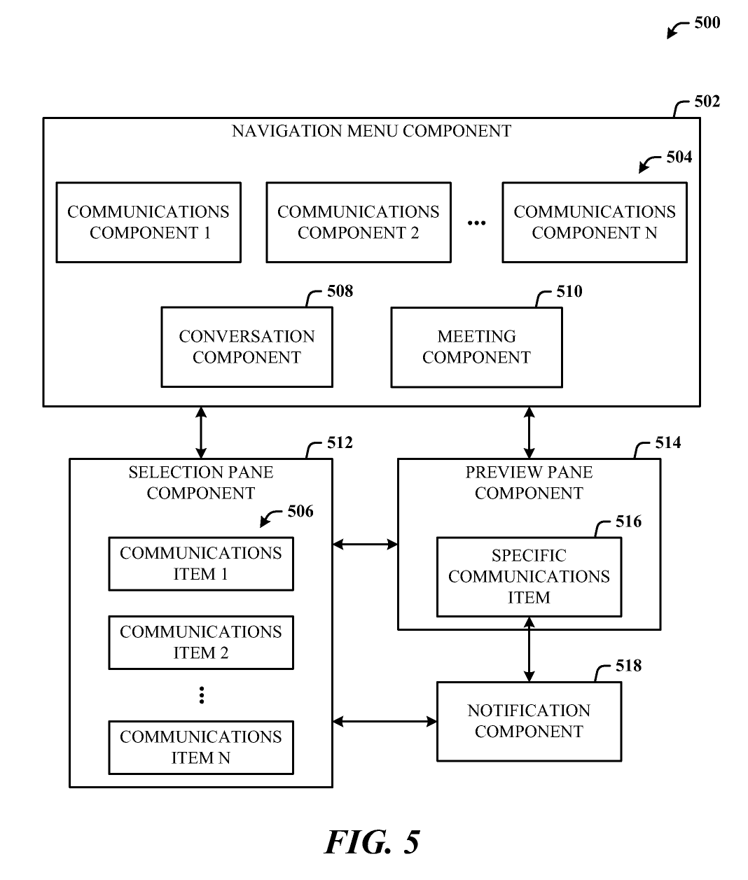

FIG. 5 illustrates an alternative embodiment of a computer-implemented system 500 for performing communications. A navigation menu component 502 enables the user to select between multiple communications components 504 that include communications items 506, as set forth hereinbelow. The communications components 504 include a conversation component 508 (similar to conversation component 108 of FIG. 1) and a meeting component 510 (similar to meeting component 102 of FIG. 1), which are components that provide representations of a conversation environment and a meeting environment in a single communications application, rather than separate application environments, as typical with previous-type systems.

As illustrated in FIG. 5, the conversation component 508 provides the user with a conversation environment in which the communications items 506 include one or more conversation threads presented in one or more a conversation formats. The conversation format can include any suitable format, such as those associated with instant messaging, group chat, a telephone call, voice or audio, video, email, application sharing, and/or meeting formats.

As also illustrated in FIG. 5, the meeting component 510 provides the user with a meeting environment in which the communications items 506 include one or more meetings. As mentioned in connection with the aforementioned embodiment, the meeting component 510 can include aspects of managing meeting history, upcoming meetings, and managing meeting content within the real-time communications environment.

As also illustrated in FIG. 5, the navigation menu component 502 includes selection options for different communications component types selected from the communication components 504, in addition to the conversation component 508 and the meeting component 510. These different communications component types can include components for “people & groups” and “phone” environments, for example. Combining multiple different communication environments together in a single communication application brings a new dimension to how users manage a communications experience.

FIG. 5 also illustrates a selection pane component 512 for displaying a list of the communications items 506. The selection pane component 512 can be a section of a user interface in the communications application that enables the user to quickly scan the communications and select an item, for example, by clicking a specific item to open or resume a communications session (e.g., a conversation thread or meeting). A preview pane component 514 displays a preview of a specific communications item 516 from the list of communications items 506. In this way, the user can view the content of the specific communications item before deciding whether or not to open or resume.

FIG. 5 also illustrates a notification component 518 for indicating a new active communication item or a missed communication item. The notification component 518 particularly denotes activity in the conversation environment. For example, if the user is engaged in five active or open conversations, and if one of the conversations has an unread message, the conversation environment will notify the user of this unread message using the notification component 518. The notification component 518 can be a flag or icon or other visually discernable element, on the interface for example, that draws attention to that specific conversation. The notification component 518 can notify the user of new activity in active conversations and can also notify the user of missed conversations. The notification component 518 can also include an audible indicator to audibly alert the user.

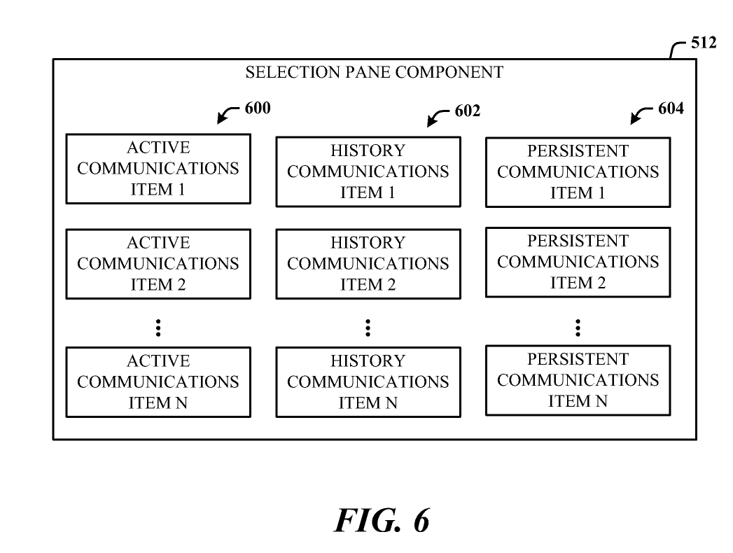

FIG. 6 illustrates additional aspects of the types of conversations items displayed in the selection pane component 512. The selection pane component 512 includes a list of active communications items 600. This can include active conversation threads or meetings. The selection pane component 512 can also include a list of history communications items 602, which can include past conversation threads and meetings. A list of persistent communications items 604 can also be presented in the selection pane component 512, which include ongoing communications between multiple user participants.

As described hereinabove the communication system 500 can define a conversation environment and a meeting environment in a single communications application. However, the communication system 500 and the associated application can also include a “people & groups” environment and “phone” environment. In such an implementation, the navigation menu component 502 can provide a conversation environment that enables users to manage active, past and persistent conversations, along with a meeting environment that enables users to manage communications around scheduled and ad hoc collaborations among users and topics.

As disclosed herein, the subject embodiments provide a single unified user experience that provides meetings and conversations and other types of conversations to be managed as objects for initiating communication and collaboration, regardless of the storage or data source. In this way, the subject embodiments provide advantages over previous systems that employ unrelated applications that store various communications in different, unassociated locations.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

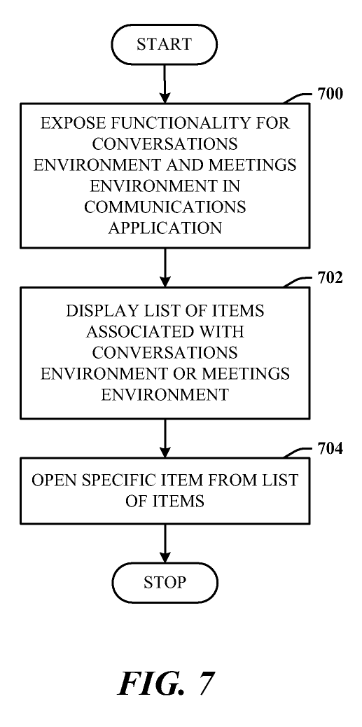

FIG. 7 illustrates a method of communications employing multiple communication environments. At 700, functionality for a conversations environment and a meetings environment is exposed in a communications application. At 702, a list of items associated with the conversations environment or the meetings environment is displayed. At 704, a specific item is opened from the list of items. In this way, a user is able to select between the conversations environment and the meetings environment (as well as other environments), and interact thereby to perform multiple communications operations.

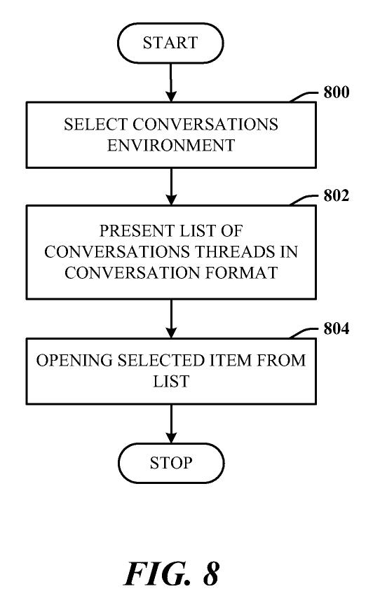

FIG. 8 illustrates further aspects in the method of communications. At 800, the conversations environment is selected. At 802, a list of communications threads in a conversation format is presented to the user in response to selection of the conversations environment by the user, who can select from the list. This list of communications threads corresponds to the list of items at 702 (of FIG. 7), as relating to the conversations environment. At 804, a selected item from the list of communications threads is opened, which corresponds to the opening of the specific item at 704 (of FIG. 7), as pertaining to the communications environment. Once the selected conversation thread is opened, the user can review or continue the conversation.

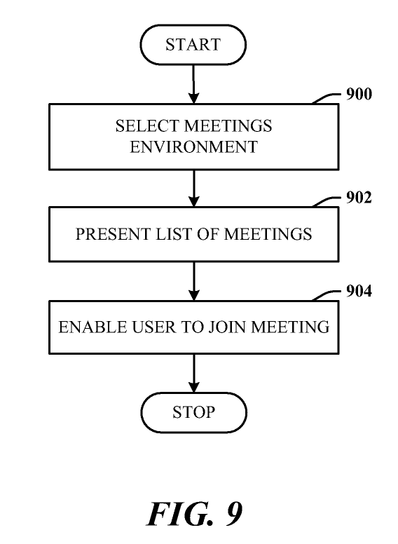

FIG. 9 illustrates additional aspects in a method of communications. At 900, the meetings environment is selected. At 902, a list of meetings is presented to the user in response to selection of the meetings environment by the user, in order to select a meeting from the list. This list of meetings corresponds to the list of items at 702 (of FIG. 7), as relating to the conversations environment. At 904, the user is enabled to join a selected meeting, and this corresponds to the opening of the specific item at 704 (of FIG. 7), as pertaining to the meetings environment. Once the selected meeting is joined, the user can participate in the meeting.

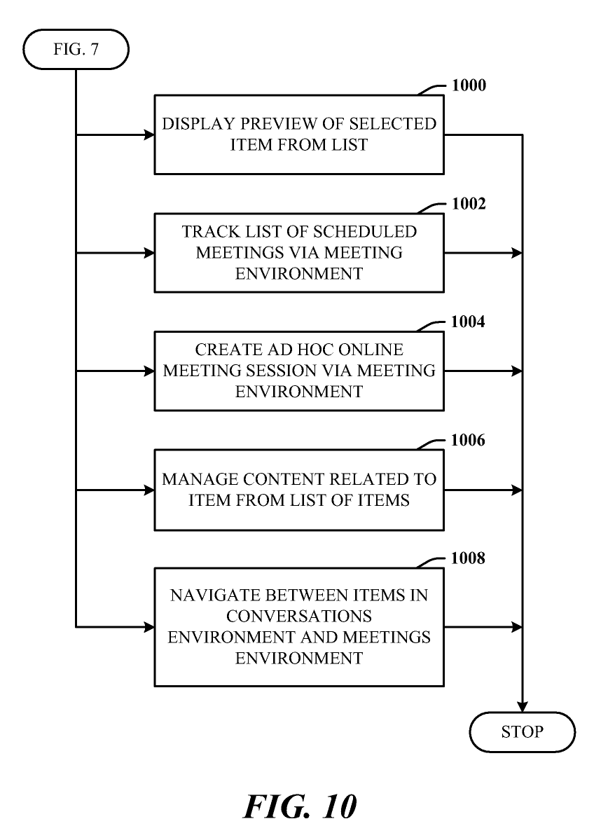

FIG. 10 illustrates still further aspects in a method of communications of FIG. 7. At 1000, a preview of the specific item from the list of items is displayed. This enables the user to review the specific item before opening. At 1002, a list of scheduled online meetings is tracked via the meetings environment. At 1004, an ad hoc online meeting can be created via the meetings environment. In this manner, the user can manage multiple meetings and create new meetings as needed. At 1006, content related to an item from the list of items can be managed. This content can be any sort of documents or files that are used during a meeting or conversation, or used before to prepare or after to review. At 1008, the user can navigate between items in the conversations environment and the meetings environment. For example, a user can select between conversations beginning with a phone calling, and into which past conversations and follow up meetings are accessed. The user can cycle between people-interactive conversation and meetings environments.

Additionally, it is to be appreciated that one or more different communications environment types can be selected in the communications application. These different communications environment types are different from the conversations environment and meetings environment, and can be suitably used for any different sort of communication that might be contemplated by a user.

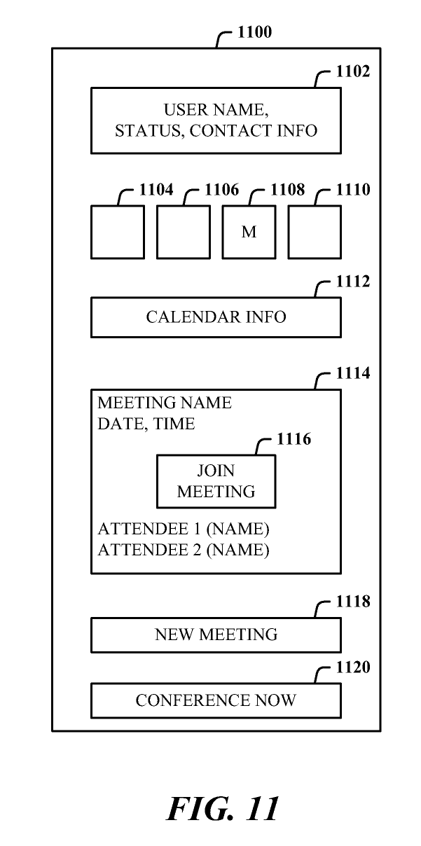

FIG. 11 illustrates a user interface 1100 that can be employed by a communications application for establishing and accessing a meeting environment. It is to be appreciated that this user interface 1100 is depicted by way of example, and any suitable interface can be contemplated for implementing the intended functionality. The interface 1100 can be a graphical user interface (GUI) used with a computer, but can also be any other suitable interface comprised of buttons, panels, panes, windows, menus, and the like.

As illustrated in FIG. 11, the interface 1100 includes an identification display 1102 that can display a user name, status, contact information, and any other suitable information relevant to the user. One or more communications environments are accessible through navigation selectors, for example, a phone selector 1104, a people & groups selector 1106, a meetings selector 1108, and a conversations selector 1110. The meetings selector 1108 is indicated as selected, shown with an “M.” Other fields display information relevant to meetings, and the information in these fields varies depending if another selector is selected. Calendar information 1112 is also displayed, to indicate the date and time, and the user's availability until a specific time.

FIG. 11 also shows a meeting information field 1114 that displays information of a specific meeting. This information can include the meeting name, the date, time and other identifying indicia, and a list of attendees, with attendee job titles or positions, for example. In this way, the meeting information field 1114 can display a real-time presence for meetings and attendees. At a higher level, the meeting information field 1114 can display a list of upcoming online meetings. Upon selection of a specific meeting, the meeting information field 1114 can refresh to display the aforementioned information shown in FIG. 11.

The meeting information field 1114 can also be selected to display tagged meetings. These are meetings that are tagged by the user so the meetings can be viewed inside the meeting environment. A MAPI (messaging application programming interface) property on a meeting stored in the communications application can allow querying for tagged meetings. Alternatively, the application can maintain a reference to GUIDs (globally unique IDs) of tagged meetings, as a separate object in a local or server application.

FIG. 11 also shows a join meeting button 1116 that enables the user to join a selected online meeting (e.g., with one click). A new meeting button 1118 enables the user to schedule a new meeting, and thereafter invite users to join at an appointed time. A conference now button 1120 is a one-click option that allows user to start an ad hoc collaboration session by inviting other users to a virtual conference room that is assigned to the user. Additionally, the interface 1100 can include integrated options for accessing meeting content, such as documents and files to be used during a meeting, or prior to or after the meeting. The interface 1100 can also include a search functionality to enable the user to search meetings based on metadata incorporated into a meeting file or a separate associated file.

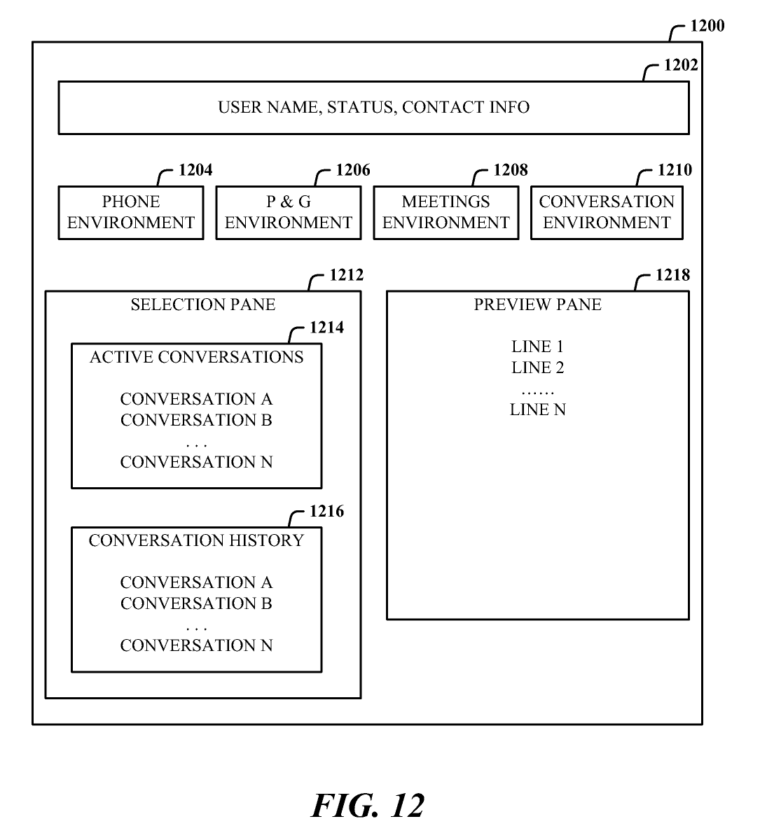

FIG. 12 illustrates a user interface 1200 for accessing a conversations environment and a meeting environment. The interface 1200 indicates the selection of multiple communications environments in a single communication application, and specifically depicts a conversation environment, where the associated fields display respective elements. It is to be appreciated that this user interface 1200 is depicted by way of example, and any suitable interface can be contemplated for implementing the intended functionality. The interface 1200 can be a GUI used with a computer, but can also be any other suitable interface comprised of buttons, displays and the like.

As illustrated in FIG. 12, the interface 1200 includes an identification display 1202 that can display a user name, status, contact information, and any other suitable information relevant to the user. A navigation menu of multiple communications environments is accessed by navigational tabs, including a phone environment selector 1204, a people & groups environment selector 1206, a meetings environment selector 1208, and a conversations environment selector 1210, the latter of which being the selected selector in this example. Other fields display information relevant to conversations, and the information in these fields varies in the event that another selector is selected.

FIG. 12 also shows a selection pane 1212 that displays information related to conversations. This information can include an active conversations list 1214 and a conversation history list 1216, which shows past conversations that are stored locally or on a network server. Selecting an item from the active conversation list 1214 enables a user to join a conversation thread in progress. Clicking an item from the conversation history list 1216 re-initiates the past conversation. The active conversations list 1214 and the conversation history list 1216 can include a conversation name, the date, time and other identifying indicia, including participants. The active conversations list 1214 and the conversation history list 1216 can also include identifying indicia such as the type of conversation thread, for example, whether it is instant messaging, group chat, phone call, online meeting, application sharing session, or any other suitable unified communications modality.

The selection pane 1212 illustrated in FIG. 12 can optionally include a persistent conversations list (not shown) that allows access to ongoing conversations. Persistent conversations can be held in active chat rooms created by users around topics or groups of users. These conversations can be stored on a network server to be accessed by any user at any desired time. A search feature (not shown) can be enabled to allow users to search across all types of conversations, and searching for keywords or embedded metadata tags.

FIG. 12 illustrates a preview pane 1218 that can display the contents of an active or saved conversation thread with actively accessing the thread. As depicted, the preview pane 1218 can be a line-by-line display of an instant messaging thread, also identifying the participants and the time of the conversation.

As described hereinabove, the subject embodiments provide a single application for accessing multiple communications environments, and multiple types of communications formats within a particular environment. The subject embodiments enable a user to quickly look to observe and navigate active communications and communications history items. Selecting items on lists and previewing items enables quick and convenient navigation and management, enabling users to leverage all available communications information in a single application.

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

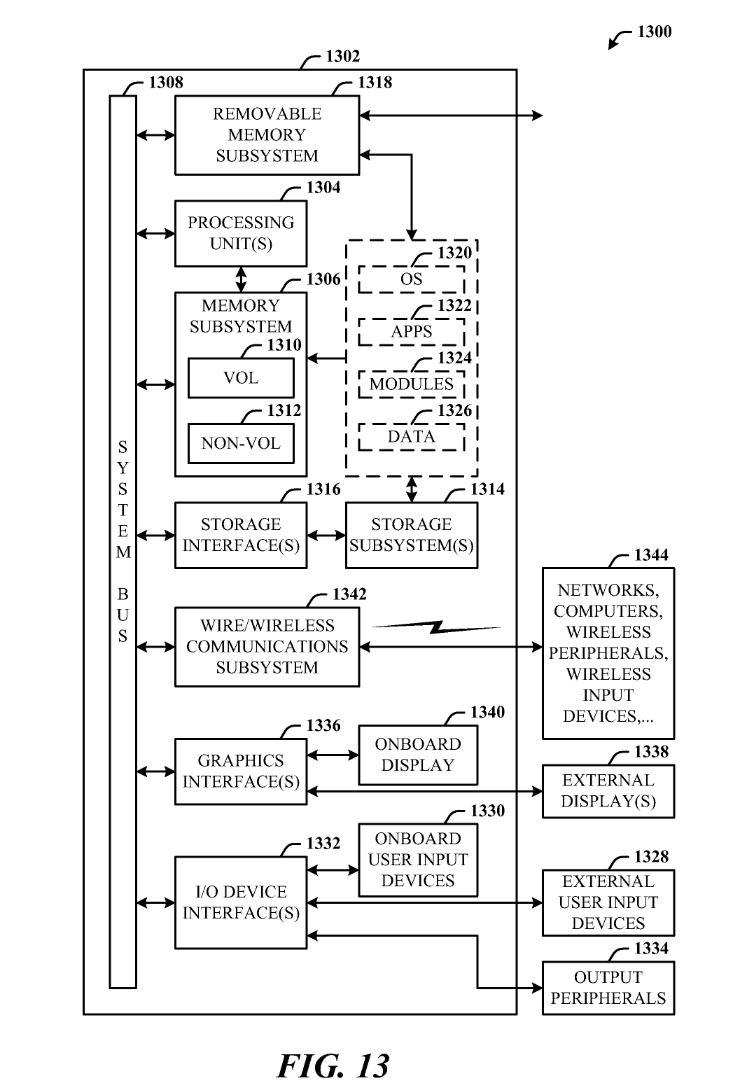

Referring now to FIG. 13, there is illustrated a block diagram of a computing system 1300 operable to execute communications in accordance with the disclosed architecture. In order to provide additional context for various aspects thereof, FIG. 13 and the following discussion are intended to provide a brief, general description of the suitable computing system 1300 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1300 for implementing various aspects includes the computer 1302 having processing unit(s) 1304, a system memory 1306, and a system bus 1308. The processing unit(s) 1304 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1306 can include volatile (VOL) memory 1310 (e.g., random access memory (RAM)) and non-volatile memory (NON-VOL) 1312 (e.g., ROM, EPROM, EEPROM, etc.). A basic input/output system (BIOS) can be stored in the non-volatile memory 1312, and includes the basic routines that facilitate the communication of data and signals between components within the computer 1302, such as during startup. The volatile memory 1310 can also include a high-speed RAM such as static RAM for caching data.

The system bus 1308 provides an interface for system components including, but not limited to, the memory subsystem 1306 to the processing unit(s) 1304. The system bus 1308 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1302 further includes storage subsystem(s) 1314 and storage interface(s) 1316 for interfacing the storage subsystem(s) 1314 to the system bus 1308 and other desired computer components. The storage subsystem(s) 1314 can include one or more of a hard disk drive (HDD), a magnetic floppy disk drive (FDD), and/or optical disk storage drive (e.g., a CD-ROM drive DVD drive), for example. The storage interface(s) 1316 can include interface technologies such as EIDE, ATA, SATA, and IEEE 1394, for example.

One or more programs and data can be stored in the memory subsystem 1306, a removable memory subsystem 1318 (e.g., flash drive form factor technology), and/or the storage subsystem(s) 1314, including an operating system 1320, one or more application programs 1322, other program modules 1324, and program data 1326. Generally, programs include routines, methods, data structures, other software components, etc., that perform particular tasks or implement particular abstract data types. All or portions of the operating system 1320, applications 1322, modules 1324, and/or data 1326 can also be cached in memory such as the volatile memory 1310, for example. It is to be appreciated that the disclosed architecture can be implemented with various commercially available operating systems or combinations of operating systems (e.g., as virtual machines).

The aforementioned application programs 1322, program modules 1324, and program data 1326 can include the computer-implemented communications system 100, the meeting component 102, the communications application 104, the multiple meetings 106, the conversation component 108, and the multiple conversation threads 110 of FIG. 1, the aspects 200, the meeting schedule component 202, the list 204 of scheduled meetings, the ad hoc collaboration component 206, the ad hoc meeting 208, and the search component 210 of FIG. 2, the content management component 300, the pre-meeting content 302, and the post-meeting content 304 of FIG. 3, the conversation threads 400, the active conversation threads 402, the past conversation threads 404, and the persistent conversation threads 406 of FIG. 4.

The aforementioned application programs 1322, program modules 1324, and program data 1326 can also include the computer-implemented system 500, the navigation menu component 502, the multiple communications components 504, the communications items 506, the conversation component 508, the meeting component 510, the selection pane component 512, the preview pane component 514, the specific communications item 516, and the notification component 518, of FIG. 5, the list of active communications items 600, the list of history communications items 602, and the list of persistent communications items 604 of FIG. 6.

The aforementioned application programs 1322, program modules 1324, and program data 1326 can further include the user interface 1100, the identification display 1102, the phone selector 1104, the people & groups selector 1106, the meetings selector 1108, the conversations selector 1110, the calendar information 1112, the meeting information field 1114, the join meeting button 1116, the new meeting button 1118, and the conference now button 1120 of FIG. 11, the user interface 1200, the identification display 1202, the phone environment selector 1204, the people & groups environment selector 1206, the meetings environment selector 1208, the conversations environment selector 1210, the selection pane 1212, the active conversations list 1214, the conversation history list 1216, and the preview pane 1218 of FIG. 12, and the methods of FIGS. 7-10, for example.

The storage subsystem(s) 1314 and memory subsystems (1306 and 1318) serve as computer readable media for volatile and non-volatile storage of data, data structures, computer-executable instructions, and so forth. Computer readable media can be any available media that can be accessed by the computer 1302 and includes volatile and non-volatile media, removable and non-removable media. For the computer 1302, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 1302, programs, and data using external user input devices 1328 such as a keyboard and a mouse. Other external user input devices 1328 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1302, programs, and data using onboard user input devices 1330 such a touchpad, microphone, keyboard, etc., where the computer 1302 is a portable computer, for example. These and other input devices are connected to the processing unit(s) 1304 through input/output (I/O) device interface(s) 1332 via the system bus 1308, but can be connected by other interfaces such as a parallel port, IEEE 1394 serial port, a game port, a USB port, an IR interface, etc. The I/O device interface(s) 1332 also facilitate the use of output peripherals 1334 such as printers, audio devices, camera devices, and so on, such as a sound card and/or onboard audio processing capability.

One or more graphics interface(s) 1336 (also commonly referred to as a graphics processing unit (GPU)) provide graphics and video signals between the computer 1302 and external display(s) 1338 (e.g., LCD, plasma) and/or onboard displays 1340 (e.g., for portable computer). The graphics interface(s) 1336 can also be manufactured as part of the computer system board.

The computer 1302 can operate in a networked environment (e.g., IP) using logical connections via a wire/wireless communications subsystem 1342 to one or more networks and/or other computers. The other computers can include workstations, servers, routers, personal computers, microprocessor-based entertainment appliance, a peer device or other common network node, and typically include many or all of the elements described relative to the computer 1302. The logical connections can include wire/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1302 connects to the network via a wire/wireless communication subsystem 1342 (e.g., a network interface adapter, onboard transceiver subsystem, etc.) to communicate with wire/wireless networks, wire/wireless printers, wire/wireless input devices 1344, and so on. The computer 1302 can include a modem or has other means for establishing communications over the network. In a networked environment, programs and data relative to the computer 1302 can be stored in the remote memory/storage device, as is associated with a distributed system. It will be appreciated that the network connections shown are exemplary and other means of establishing a communications link between the computers can be used.

The computer 1302 is operable to communicate with wire/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can also be practiced in distributed computing environments where certain tasks are performed by remote processing devices that are linked through a communications network. In a distributed computing environment, program modules can be located in local and/or remote storage and/or memory system.

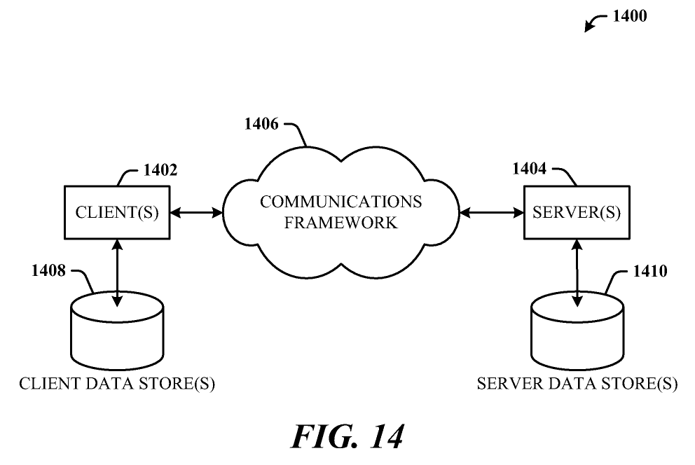

Referring now to FIG. 14, there is illustrated a schematic block diagram of a computing environment 1400 that can be used for communications. The environment 1400 includes one or more client(s) 1402. The client(s) 1402 can be hardware and/or software (e.g., threads, processes, computing devices). The client(s) 1402 can house cookie(s) and/or associated contextual information, for example.

The environment 1400 also includes one or more server(s) 1404. The server(s) 1404 can also be hardware and/or software (e.g., threads, processes, computing devices). The servers 1404 can house threads to perform transformations by employing the architecture, for example. One possible communication between a client 1402 and a server 1404 can be in the form of a data packet adapted to be transmitted between two or more computer processes. The data packet may include a cookie and/or associated contextual information, for example. The environment 1400 includes a communication framework 1406 (e.g., a global communication network such as the Internet) that can be employed to facilitate communications between the client(s) 1402 and the server(s) 1404.

Communications can be facilitated via a wire (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented communications system, comprising:
a meeting component of a communications application for selecting a meeting from multiple meetings; and
a conversation component of the communications application for managing multiple conversation threads.

2. The system of claim 1, further comprising a meeting schedule component for tracking scheduled online meetings defined according to a list.

3. The system of claim 1, further comprising an ad hoc collaboration component for creating an ad hoc meeting.

4. The system of claim 1, further comprising a search component for performing searches of the multiple meetings.

5. The system of claim 1, wherein the multiple conversation threads are associated with at least one of instant messaging, group chat, telephone calls, or an online meeting.

6. The system of claim 1, further comprising a content management component for managing pre-meeting content and post-meeting content related to at least one of the multiple meetings.

7. The system of claim 1, wherein the conversation threads include active conversation threads, past conversation threads, and persistent conversation threads.

8. A computer-implemented communications system, comprising:
a navigation menu component for selecting between communications components that include communications items, the communications components include,
a conversations component of a real-time communications application in which the communications items comprise at least one conversation thread in a conversation format; and
a meeting component of the real-time communications application in which the communications items comprise at least one meeting;
a selection pane component for displaying a list of the communications items; and
a preview pane component for displaying a preview of a specific communications item from the list.

9. The system of claim 8, wherein the conversation format is associated with instant messaging, group chat, a telephone call, voice, video, email, application sharing, or an online meeting.

10. The system of claim 8, wherein the selection pane component includes a list of active communications items, a list of history communications items, and a list of persistent communications items.

11. The system of claim 8, further comprising a notification component for indicating a new active communication item or a missed communication item.

12. A computer-implemented method of communications, comprising:
exposing functionality for a conversations environment and a meetings environment in a communications application;
displaying a list of items associated with the conversations environment or the meetings environment; and
opening a specific item from the list of items.

13. The method of claim 12, further comprising presenting a list of conversation threads in a conversation format in response to selection of the conversations environment.

14. The method of claim 12, further comprising presenting a list of meetings in response to selection of the meetings environment.

15. The method of claim 12, further comprising exposing functionality that enables a user to join a meeting.

16. The method of claim 12, further comprising displaying a preview of the specific item from the list.

17. The method of claim 12, further comprising tracking a list of scheduled online meetings via the meetings environment.

18. The method of claim 12, further comprising creating an ad hoc online meeting via the meetings environment.

19. The method of claim 12, further comprising managing content related to an item from the list of items.

20. The method of claim 12, further comprising navigating between items in the conversations environment and the meetings environment via a single user interface.
